(19) United States
(12) Patent Application Publication
(10) Pub. No.: US 2025/0318481 A1
(43) Pub. Date: Oct. 16, 2025

(54) Self-Irrigating Pot

(71) Applicant: Edimar Cardoso Binotti, JR., Domingos Martins (BR)

(72) Inventor: Edimar Cardoso Binotti, JR., Domingos Martins, ES (BR)

(21) Appl. No.: 19/109,031

(22) PCT Filed: Aug. 24, 2023
(86) PCT No.: PCT/BR2023/050278

§ 371 Date: Mar. 5, 2025

(30) Foreign Application Priority Data
Sep. 5, 2022 (BR) 102022017795-3

(51) Int. Cl. A01G 27/02; A01G 9/02

(52) U.S. Cl. CPC A01G 27/02; A01G 9/02

(57) ABSTRACT

The present invention relates to a self-watering pot (100), which comprises: a side wall (110); a base (120) associated with the side wall (110); and a spillway (130) associated with the base, wherein the spillway (130) comprises at least one drainage hole (132), wherein the pot (100) internally comprises a bottom reservoir (150) defined between the side wall (110), the spillway (130), the base (120), and at least one drainage hole (132), wherein the drainage hole (132) is configured to drain excess liquid present inside the pot.

The present invention refers to a pot for plant development, maintenance and self-watering or self-hydrating. More specifically, the present invention refers to a self-watering pot with an internal liquid reservoir.

### DESCRIPTION OF THE STATE OF THE ART

The most popular and widely marketed pots for planting seeds, seedlings, and plants have a lower saucer, on which the pot containing holes in the base rests. These lower saucers prevent the contact of the irrigation water from the pot with the floor where the pot is located, in addition to enabling the return of water by capillarity. A serious problem with these pots identified in recent times is the accumulation of standing water in the saucers, which favors the proliferation of mosquitoes, especially the mosquito Aedes aegypti, a transmitter of viruses that cause three dangerous diseases: Dengue, Zika and Chikungunya. In addition, the most common pots require attention to the frequency of watering the soil or substrate, as the possibility of self-watering is not foreseen. In some cases, “self-watering” occurs, however, it is external, with the risk of mosquito breeding.

The eventual absence of holes in the pot can lead to excessive accumulation of water inside, resulting in the potential rotting of the plant's root (unless it is “aquatic”).

Other well-known pots that aim to mitigate these issues of external water accumulation, excessive internal water accumulation, and the need for frequent irrigation are self-watering pots that utilize an internal water reservoir, but are separated from the soil. Problems with these pots include construction complexity (they usually use more than one structure to separate the soil or substrate from the water, and often a means of transporting water, such as a cotton thread) and difficulty in storage and transport (due to the construction complexity, stacking for storage and transport is hindered).

Therefore, it is noted that a solution is missing in the state of the art for pots capable of providing the ease of self-watering with internal humidity control, combined with constructive simplicity, ease of storage and transport, prevention of mosquito proliferation, and reduced evaporation.

### OBJECTIVES OF THE INVENTION

In view of the issues mentioned, one objective of the present invention is to provide a pot that prevents the accumulation of standing water in the external region of the pot, thus avoiding problems such as mosquito proliferation.

An additional objective of the present invention is to provide a pot that decreases the evaporation of the irrigation liquid by keeping the liquid internally in the pot.

Another objective of the present invention is to provide a pot with constructive simplicity, allowing for easy stacking, storage, and transport, resulting in space and time savings.

Another objective of the present invention is to provide a pot with appropriate sizing for adequate control of the moisture of the substrate or soil contained in the pot, without renouncing the other objectives and advantages already mentioned.

### BRIEF DESCRIPTION OF THE INVENTION

The present invention refers to a self-watering pot, which comprises a side wall, a base associated with the side wall, and a spillway associated with the base. The spillway comprises at least one drainage hole, and the pot internally comprises a bottom reservoir defined between the side wall, the spillway, the base, and at least [one] two drainage holes, in which the drainage holes are configured to drain excess liquid present inside the pot.

The pot can also include a movable lid, in which the movable lid is associated with the spillway to create a drainage region. The shape of the side wall can be tapered, or any other shape that makes stacking easier; not excluding ornamental walls with a lesser fit and greater beauty. The spillway may comprise a tubular body, which includes two drainage holes, where the spillway is positioned concentrically at the base. Alternatively, the spillway may comprise a tubular body, which includes two drainage holes, where the spillway is positioned eccentrically at the base, promoting the planting of larger plants and/or a larger irrigation reserve.

The ratio of the distance between the base and the top of the spillway and the distance between the base and the opposite end of the side wall can be between 30% and 40%. The ratio of the distance between the base and the beginning of the drain and the distance between the base and the opposite end of the side wall can be between 22% and 32%. The ratio of the base diameter and top diameter can be between 70% and 80%.

### BRIEF DESCRIPTION OF THE DRAWINGS

The present invention will be described in more detail below based on an execution example represented in the drawings. The figures show:

FIG. 1—a perspective view of an embodiment of the pot of the present invention with the lid detached;

FIG. 2—a perspective view of an embodiment of the pot of the present invention with the lid fitted;

FIG. 3—a perspective view with a side section of an embodiment of the lid of the present invention;

FIG. 4—a side-sectional view of an embodiment of the pot (section A-A) and the lid (section B-B) of the present invention;

FIG. 5—a side-section view of an embodiment of the pot of the present invention illustrating the drainage of excess water;

FIG. 6—a side-sectional view of an embodiment of the pot of the present invention illustrating a stable liquid level;

FIG. 7—a side-sectional view of a stacking of the pot and lid of the present invention; and

FIG. 8—a side-section view of an embodiment of the pot of the present invention with scale relationships.

### DETAILED DESCRIPTION OF THE DRAWINGS

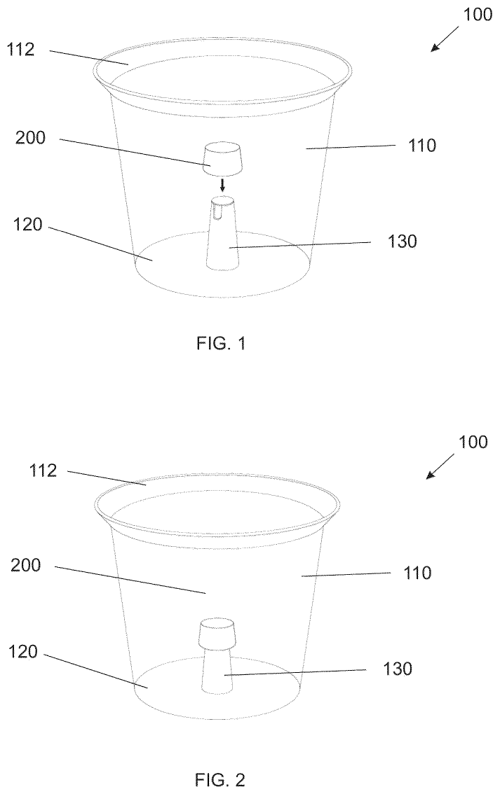

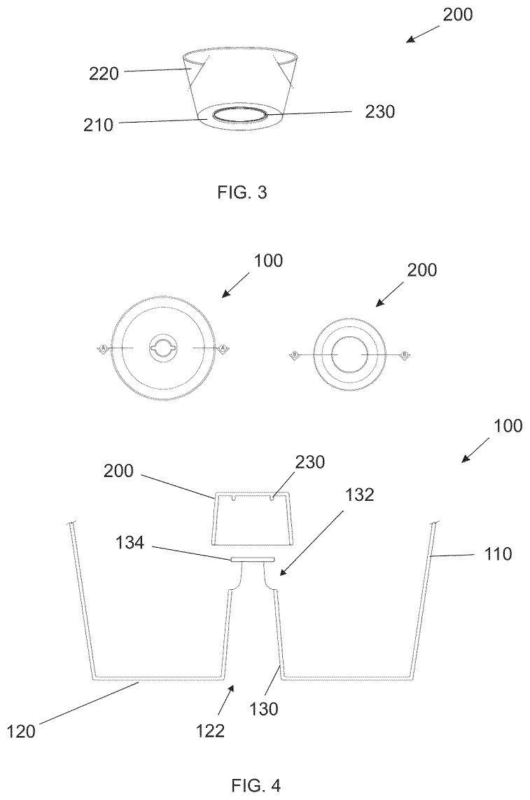

FIGS. 1 and 2 illustrate perspective views of an embodiment of pot 100 of the present invention. FIG. 3 illustrates a movable lid 200 of the pot 100 of the present invention. FIG. 4 illustrates a sectional view of sections A-A for the pot and B-B for the movable lid 200 identified in the top views of the details in FIG. 4.

The term “liquid”, used throughout this report, should be understood as a liquid commonly used for irrigation of a pot, whether it is pure water or any other type of solution suitable for fertigation of soil and/or substrate.

The pot 100 of the present invention comprises a side wall 110, a base 120, a spillway 130, and the movable lid 200. FIG. 1 illustrates an embodiment of the pot 100 of the present invention with the lid 200 detached, and FIG. 2 an embodiment with the lid 200 fitted into the spillway 130; in addition to the eave 112.

The main function of the side wall 110 is to keep the soil, substrate, irrigation liquid, and any other elements inside the pot 100. The side wall 110 of the pot 100 associates with the base 120 to define the inner region of the pot 100. In the illustrated embodiment, the side wall 110 extends from the perimeter of the base 120. In this embodiment, the shape of the 110 side wall is conical.

Other formats may be used on the side wall 110 in other embodiments of the present invention, including embodiments with multiple side walls. Examples include pyramidal shape, arched, among others.

In one embodiment, the side wall 110 comprises an eave 112, which extends from the end of the wall opposite the base 120. The eave 112 increases the diameter of the end of the pot 100, enhancing the aesthetics and retention of the elements that fill the interior of the pot 100 during use thereof. In addition, the eave 112 provides a funnel effect that makes it easy to fit one pot into the other during stacking for storage and/or transport.

The main function of the base 120 as well as the side wall 110 is to keep the soil, substrate, irrigation liquid, and any other elements inside the pot 100. As mentioned, its association with the side wall 110 defines the inner region of the pot 100.

In this embodiment, unlike known pots, which have holes that connect the interior of the traditional pot directly with the outer base, the base 120 comprises a liquid passage opening 122 associated with the spillway 130, through which an excess of liquid flows. In the illustrated embodiment, the base 120 has a circular flat shape with a central passage opening 122, from which the spillway 130 extends. These characteristics prevent all the liquid from exiting the interior of the pot 100 to the outside and create a bottom reservoir region 150, which will be described later.

The spillway 130 is an element of the pot 100 that associates with the base 120 to define the internal region of the pot 100. The spillway 130 is also responsible for defining the reserve fund 150, together with the base 120 and the side wall 110. In addition, it is responsible for releasing (draining) the excess liquid present inside the pot 100 to the outside of the pot 100 through at least one, or as illustrated in the embodiment, two drainage holes 132. In the illustrated embodiment, the spillway 130 is positioned concentrically at the base 120, providing more efficient drainage. In alternative embodiments, the spillway may not be positioned concentrically at the base 120.

In the illustrated embodiment, the spillway 130 comprises a rigid conical tubular body equipped with drainage holes 132, more specifically, two drainage holes 132 present in the wall of the tubular body. The tubular body of the spillway 130 also comprises a closed end 134 on the opposite side of the base 120. In other embodiments, the pot 100 may comprise a single drainage hole 132 or a plurality of drainage holes 132. In other embodiments, the shape of the spillway can be pyramidal, arched, among other similar ones.

In this embodiment, the drainage holes 132 are positioned at the end of spillway 130 opposite the base 120 (closed end 134). In addition, the drainage holes 132 comprise an oblong shape with a semicircular end. This format helps with better drainage of excess liquid.

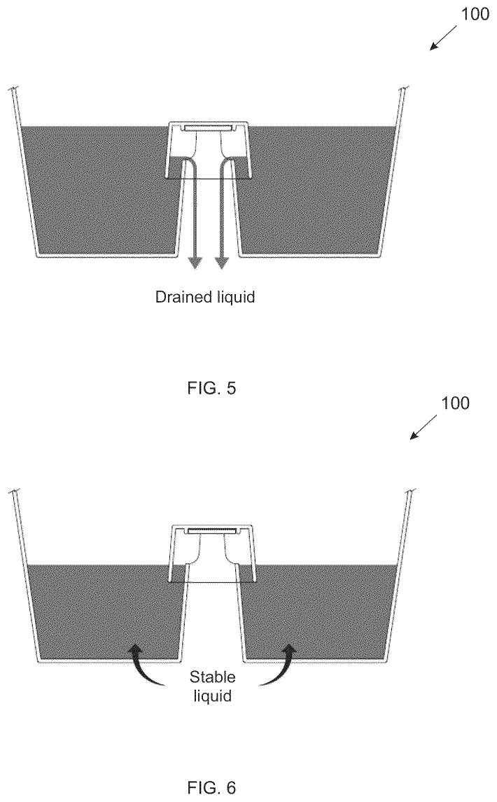

The drainage holes 132 are responsible for draining or emptying the excess liquid present inside pot 100, as can be seen in FIGS. 5 and 6. In this way, the position of the drainage holes 132 at the end of the spillway 130 keeps the liquid at the desired level, thus forming the bottom reservoir 150.

The bottom reservoir 150 is the volume comprised or defined between the base 120, side wall 110, spillway 130, and drainage holes 132. Its main objective is to control the accumulation of liquid inside the pot 100, maintaining an adequate volume for the proper irrigation/hydration of the plants present in the pot 100. The volume of liquid exceeding the bottom reservoir 150 is drained through the drainage holes 132 out of the pot 100 of this invention.

In the illustrated embodiment, the pot 100 of the present invention also includes the lid 200, seen in detail in FIG. 3. The lid 200 is responsible for assisting in the control of the level of the bottom reservoir 150, protecting the drainage holes, and preventing the blockage of the drainage holes 132 by soil, substrate, and/or roots.

The lid 200 comprises a lid surface 210 and a lid wall 220 associated with the lid surface 210. The lid wall 220 extends from the perimeter of the lid surface 210. In this embodiment, the shape of the lid wall 220 is conical, however, other shapes can be used.

The lid 220 is snap-on, meaning it connects to the end of the spillway 130 opposite the base 120 through a snap shoulder 230 located on the lid surface 210 and designed to attach to the edge of the spillway end 130. Thus, a better firmness is obtained in the fitting of the lid 220 with the pot 100 and a better drainage of excess liquid; in addition to the release of the flow in extreme cases of root clogging.

The association of the lid 220 with the spillway 130 creates a drainage region. The drainage region is defined between the lid wall 220 and the spillway 130, and allows the drainage of excess liquid without clogging with soil, substrate, and/or even root accumulation.

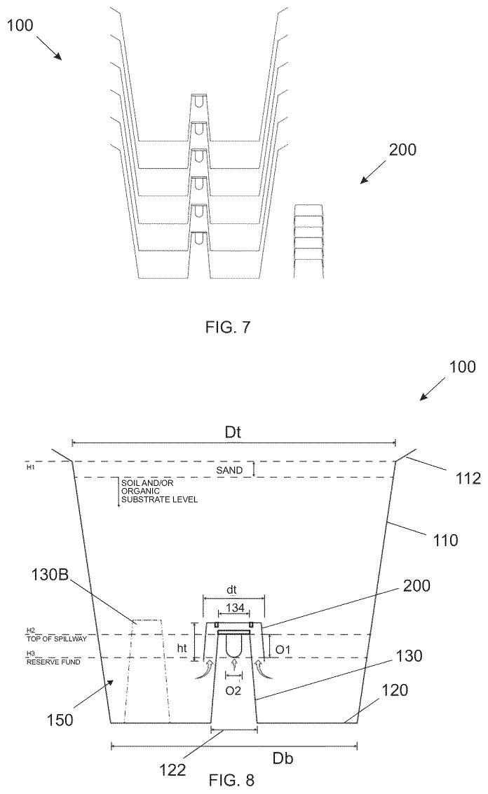

The formats described for the illustrated embodiments of the pot 100 and lid 220 of this invention provide a stacking advantage for storage and/or transport of this invention. FIG. 7 illustrates this stacking advantage of both the pot 100 and the lid 220.

FIG. 8 illustrates the dimensions of an embodiment of pot 100 of the present invention. For possible embodiments of this invention, all values can be adjusted up or down by 5%, 10%, 20%, 30%, 50%, 75%, and/or 90% or more, allowing for large dimensions of this invention, as long as the proper ratios are maintained when necessary.

In this embodiment, the side wall 110 comprises a top diameter Dt between approximately 17 cm and 25 cm. In this embodiment, the side wall 110 comprises a base diameter Db between approximately 13 cm and 19 cm. Another way to determine the dimensioning of the side wall diameters 110 illustrated is the ratio between the top diameter Dₜ and the base diameter D_{b}. In the illustrated embodiment, the base diameter Db comprises approximately between 70% and 80% of the size of the top diameter Dt, allowing large variations in volume, as long as the technical dimensions already defined are respected.

In this embodiment, the possible diameters for the end of base 120 are the same as those determined for the base diameter Db of the side wall 110. The diameter of the passage opening 122 for liquid is between approximately 2 cm and 4 cm. This is the same size as the base 120 of the spillway 130. The opposite end 134 of the spillway 130, in turn, comprises between approximately 1 cm and 3 cm.

In this embodiment, the drainage holes 132 range from approximately 0.5 cm to 2 cm in the transverse direction O₂ and from approximately 0.75 cm to 3 cm in the longitudinal direction O₁; larger drain dimensions accompany larger volumes of the self-watering pot of this invention.

In this embodiment, the lid surface 210 comprises a diameter dₜ between approximately 2 cm and 6 cm. The lid wall 220 comprises a height hₜ between approximately 1 cm and 5 cm; which increases proportionally with the volume of the pot in question.

In this embodiment, the distance H1 between the base 120 and the opposite end of the side wall 110 is approximately between 15 cm and 20 cm. The distance H2 between the base 120 and the top of the spillway 130 ranges from approximately 4 cm to 8 cm. The distance H3 between the base 120 and the beginning of the drainage hole 132, i.e., the height of the bottom reservoir 150, ranges from approximately 3 cm to 6 cm. Larger dimensions of the self-watering pot of the present invention are possible, maintaining the proportions between the heights and the diameters.

In this embodiment, the level of the substrate and/or soil to be used should be between approximately 14 cm and 19 cm, allowing for the use of a soil protection of approximately 1 cm in height A1, such protection being, for example, sand. In this case, the use of sand occurs not on the (external) saucer, as in one currently found on the market, but on the substrate of the pot 100 itself. The sand prevents excessive drying and weed infestation.

In this embodiment, the H2/H1 ratio is approximately between 30% and 40% and the H3/H1 ratio is approximately 22% to 32%.

In an alternative embodiment of the present invention, the spillway 130B is positioned eccentrically at the base 120 of the pot 100, i.e., off-center of the base 120. The spillway 130B of this embodiment has a greater length than the eccentric spillway 130 to adjust the drainage of excess liquid, allowing for larger volumes in the bottom reservoir and in the substrates of already developed seedlings.

In an alternative embodiment, a vertical column of rigid and permeable tube, with a central float, can be incorporated into the pot 100 of the present invention to control the level of liquid present in the bottom reservoir 150, only when the substrate is stable (structured).

In alternative embodiments, ornamental features can be applied to the pot 100, depending on the needs of the project and the consumer.

Having described preferred embodiments, it should be understood that the scope of the present invention encompasses other possible variations, being limited only by the content of the accompanying claims, possible equivalents included therein.

1-8. (canceled)

9. A self-watering pot, comprising:
a side wall;
a base associated with the side wall;
and a spillway associated with the base,
wherein the spillway comprises at least one drainage hole, wherein the pot internally comprises a bottom reservoir defined between the side wall, the spillway, the base, and at least one drainage hole, wherein the drainage hole is configured to drain excess liquid present inside the pot.

10. The self-watering pot of claim 9, further comprising a movable lid, in which the movable lid is associated with the spillway to create a drainage region.

11. The self-watering pot of claim 9, wherein the shape of the side wall is conical.

12. The self-watering pot of claim 9, wherein the spillway comprises a tubular body with two drainage holes, in which the spillway is positioned concentrically at the base.

13. The self-watering pot of claim 9, wherein the spillway comprises a tubular body with two drainage holes, in which the spillway is positioned eccentrically at the base.

14. The self-watering pot of claim 9, wherein the ratio of the distance between the base and the top of the spillway and the distance between the base and the opposite end of the side wall is between 30% and 40%.

15. The self-watering pot of claim 9, wherein the ratio of the distance between the base and the start of the drainage hole and the distance between the base and the opposite end of the side wall is between 22% and 32%.

16. The self-watering pot of claim 9, wherein the ratio of the base diameter and the top diameter is between 70% and 80%.
